(19) United States
(12) Patent Application Publication
(10) Pub. No.: US 2016/0053141 A1
(43) Pub. Date: Feb. 25, 2016

(54) SOLID BIOGENIC FILLERS IN ADHESIVE COMPOSITIONS FOR FIXING TECHNOLOGY

(71) Applicant: FISCHERWERKE GMBH & CO. KG, Waldachtal (DE)

(72) Inventors: Jurgen GRUN, Botzingen (DE); Martin VOGEL, Glottertal (DE); Christian SCHLENK, Denzlingen (DE); Christian WEINELT, Emmendingen (DE)

(21) Appl. No.: 14/779,832

(22) PCT Filed: Mar. 21, 2014
(86) PCT No.: PCT/EP2014/000771

§ 371 Date: Sep. 24, 2015

(30) Foreign Application Priority Data
Apr. 5, 2013 (DE) 10 2013 103 403.9

(51) Int. Cl. C09J 133/14

(52) U.S. Cl. CPC C09J 133/14; C08K 11/00

(57) ABSTRACT

Multi-component synthetic resin adhesive composition for the fixing sector, especially for adhesively bonding an anchoring element in a hole (for example, a drilled hole) or crevice, comprising fillers, which comprises a biogenic filler (for example a kernel flour or stone flour from fruit); use of the synthetic resin adhesive composition for embedding anchoring means in mortar in holes and crevices; process or method for embedding anchoring means in mortar and holes or crevices, in which the synthetic resin adhesive composition is used; and use of biogenic fillers in producing such a synthetic resin adhesive composition.

### TECHNICAL FIELD OF THE INVENTION

The invention relates to multi-component synthetic resin adhesive compositions for the fixing sector, especially for adhesively bonding an anchoring element in a hole (for example, a drilled hole) or crevice, comprising fillers and optionally further additives, and to further subject-matter of the invention mentioned hereinbelow.

### DISCUSSION OF RELATED ART

A range of (for example, injectable) fixing mortar systems (synthetic resin adhesive compositions) based on an extremely wide variety of polymer-forming components is known, sometimes in the form of single-component systems and sometimes in the form of two-component or multi-component systems, which are used for embedding anchoring means, such as bolts, anchor rods or the like, in mortar in holes, such as drilled holes, or crevices, in each case in solid substrates such as, for example, masonry or concrete. Further components, for example facing elements, can then be fixed to the anchoring means. The embedding of the anchoring means in mortar is based, on the one hand, on adhesive effects in the sense of a material-bonded connection between the synthetic resin and an anchoring element and/or the wetted surface of the hole or crevice and/or, on the other hand, on an interlocking connection, such as, for example, undercuts formed by using the synthetic mortar to surround projecting or recessed portions of the anchoring element and/or of the hole or crevice.

In the synthetic resins and plastics sector there is, for ecological and economic reasons and as a result of legislation making it favourable, a requirement to reduce the organically bound carbon content of fossil constituents (obtained, for example, from petroleum, lignite coal or bituminous coal).

Biomass and/or biosphere-based (renewable, sustainable, bio-based) or “biogenic” raw materials for carbon are sparing of resources and, because of their long-term obtainability, are of special interest.

In order to assess the proportion of bio-based raw materials it is customary to ascertain the proportion of bio-based carbon, which is detected by means of the ¹⁴C method. Because the ratio of carbon isotopes can still be determined after the production process, it is possible to distinguish between fossil and biogenic biomass.

Bio-based products can consist entirely or at least partly of bio-based raw materials. It is also possible for further additional substances, inorganic substances or fossil materials, or two or more thereof, to be included.

Efforts are being made to make standardised certifications for products with bio-based contents possible. An example is the certification program for bio-based products according to ASTM 6866 by TÛV Rheinland (DIN CERTCO, Berlin, Germany) in order to gain the right to mark a product with the certification “Bio-based . . . %, DIN-tested”, for example “Bio-based 50 to 85%, DIN-tested”.

In order to gain such certification, a double minimum requirement is imposed: firstly, the minimum content of organic material, determinable as loss on ignition, must be at least 50% by weight.

Secondly, the content of bio-based carbon must exceed 20% by weight (for a certification of “Bio-based 20 to 50%, DIN-tested”, it must be between 20 and 50% by weight; for a certification of “Bio-based 50 to 85%, DIN-tested”, it must be between 50 and 85% by weight; for a certification of “Bio-based >85%, DIN-tested”, it must be at least 85% by weight). The content is preferably >50%.

Testing of a product is carried out by taking samples from production or from marketing/selling channels (usually by the manufacturer or the seller themselves) and testing them. An initial test is carried out, and regular monitoring.

In this, the loss on ignition can be determined by customary methods. It corresponds to the amount of organic material. A known mass m₀ of test material is ashed, and the mass of the solid residue obtained m_{f} is determined and subtracted from m₀. This corresponds to the volatile and/or organic content of the test material. A high loss on ignition indicates a high organic substance content in the sample, because the carbon contained therein is oxidised and is given off in the form of carbon dioxide. The determination can be carried out, for example, in accordance with DIN EN 14775 or DIN 18128.

The bio-based carbon content is carried out on the basis of ASTM 6866 (Standard Test Method for Determining the Biobased Content of Solid, Liquid and Gaseous Samples Using Radiocarbon Analysis (ASTM International, D6866:2008, Method A).

A relatively large number of documents containing adhesives or glues based on phenolic resins (not suitable for the purposes according to the invention) have been found, of which there may be mentioned here, by way of example, U.S. Pat. No. 4,311,621 (wood bonder comprising walnut shell, or coconut shell and walnut shell (pretreated with saturated steam) as additives) and U.S. Pat. No. 2,781,286 (filler of vegetable shell flour, such as that obtained from drupes, for example walnut shell).

EP 1 978 061 A1 and EP 2 164 886 A relate to hardenable vinyl polymer materials having crosslinkable silyl groups and photopolymerisation inhibitors, which may comprise as fillers, inter alia, walnut flour. As resins there are mentioned, inter alia, (meth)acrylates, UP, styrene etc.; these relate to adhesives and sealing materials. WO 2009/009009 A2 relates to (meth)acrylate adhesives having naturally occurring fillers which have free-radical-inhibiting properties (TPP as oxygen scavenger), especially wood flour; explicit mention is made therein of inhibitory properties of lignin-containing fillers and therefore oxygen scavengers are described as being mandatory. EP 1 832 638 A1 relates to a hot-melt adhesive based on polyacrylate comprising a specific polyacrylate and, as crosslinker, isocyanate. Organic fillers are possible, for example walnut shells. WO 2008/024444 A2 relates to adhesives based on polyamidoamine-epihalohydrin resins comprising protein or lignin-containing additives and mentions cellulose materials of wood, as lignocellulosic materials, also in powder form. U.S. Pat. No. 3,419,507 mentions latex-based adhesives having carbohydrate fillers and walnut shell flour.

Simitzis, J., et al., European Polymer Journal (1996), 32(7), 857-863, wherein the waste product olive stones as a filler in single-component novolak/hexamethylene-tetramine-based bakelite-type systems resulted in an increase in the activation energy and frequency factor.

Sobukawa. T., and Kanazawa, H., Mokuzai Kogyo (1980) 35(396), 110-115, describe the use of coconut shell, wheat flour or calcium carbonate as fillers in adhesives for wood based on vinyl polyurethanes and describe a reduction in the dissolution rate of the adhesive in hot water with addition of the mentioned fillers and a reduction in the bonding strength when they are added.

The prior art accordingly relates to problems and solutions that differ from the present invention.

Various flours were then tested. In so doing, grain, wood and certain other flours soaked up the other resin components entirely so that it was possible to add only a few percent before the material was too solid to work (see, for example, hereinbelow in the Examples).

It was however found, surprisingly, that it is possible to use biogenic (solid) fillers, such as flours, brans, sugars, (poly)saccharides (which also includes modified forms thereof such as, for example, carboxymethylcelluloses), plant fibres, alkyl (poly)glycosides (for example, Simulsol from the company Seppic), tannins, lignins, lignin sulfonates or latex, or mixtures of two or more thereof, especially flours or powders obtained from plant kernels, plant shells and charcoal obtained from plants (or mixtures of two or more thereof or with the above-mentioned biogenic materials) as fillers for the multi-component synthetic resin adhesive compositions mentioned at the outset (even in relatively large proportions), without negatively affecting the properties thereof, with even positive effects being found.

Because these are biogenic (and not fossil) fillers (biogenic) materials), these flours, brans, sugars, (poly)saccharides, plant fibres, alkyl (poly)glycosides (for example, Simulsol from the company Seppic), tannins, lignins, lignin sulfonates or latex, or mixtures of two or more thereof, especially flours or powders obtained from plant kernels, plant shells and charcoal obtained from plants (or mixtures of two or more thereof or with the above-mentioned biogenic materials) make possible an increase in the content of biogenic materials in the mentioned multi-component synthetic resin adhesive compositions without their use instead of a mineral filler causing a substantial reduction or any reduction at all in pull-out values (for the measurement method for determining pull-out values it is possible to use the method mentioned in the Examples also in adhesive compositions other than those given in the Examples).

### SUMMARY OF THE INVENTION

The invention accordingly relates, in a first embodiment, to a multi-component synthetic resin adhesive composition as mentioned at the outset, characterised in that it comprises a biogenic (solid) filler in the form of biogenic materials as mentioned, especially kernel flours or kernel powders or shell flours or shell powders obtained from plant fruits and/or biogenic charcoal, or in each case mixtures of two or more thereof.

Corresponding processes and methods for embedding anchoring elements in mortar and holes or crevices, wherein a multi-component synthetic resin adhesive composition according to the invention is used for the embedding of anchoring means in mortar, wherein the synthetic resin adhesive composition and an anchoring means are successively, especially first the synthetic resin adhesive composition and then the anchoring means, or (at least substantially) simultaneously introduced into a hole or crevice in a substrate (also in a cracked substrate, such as in cracked concrete), form an embodiment of the invention.

The invention also relates, in a further embodiment, to use of the mentioned biogenic materials, especially biogenic kernel flours or kernel powders or shell flours or shell powders obtained from plant fruits and/or biogenic charcoal, or in each case mixtures of two or more thereof, as filler for multi-component synthetic resin adhesive compositions, especially for the purposes according to the invention, wherein preferably the corresponding filler is added to a composition of such a kind.

The definitions hereinbelow serve to clarify certain terms or symbols and to describe special embodiments of the invention; in the embodiments of the invention mentioned hereinabove and hereinbelow it is possible for individual, some or all terms or symbols to be replaced by more specific definitions, resulting in special embodiments of the invention.

Biogenic means preferably that the fillers (or other biogenic components) are obtained from plants or from vegetable and/or animal, especially vegetable, materials.

Where weights are given in percent (% by weight), these relate, if not otherwise stated, to the total mass of the reactants and additives of the synthetic resin adhesive composition according to the invention (that is to say to the constituents and/or their precursors present in the material to be cured after mixing, without packaging, except in the case of capsules or films which can also act as fillers and make a contribution to the total mass of the hardening or hardened material, and without other possible parts such as static mixers, cartridge housings or the like).

Where (meth)acrylates are mentioned, this means acrylates, methacrylates or mixtures thereof.

Biogenic fillers (materials) are, for example, flours, brans, sugars, (poly)saccharides, plant fibres, alkyl (poly)glycosides (for example, Simulsol from the company Seppic), tannins, lignins, lignin sulfonates or latex, or mixtures of two or more thereof, especially flours or powders obtained from plant kernels, plant shells and charcoal obtained from plants (or mixtures of two or more thereof or with the above-mentioned biogenic materials).

The kernel flours or kernel powders or shell flours or shell powders obtained from plant fruits which are preferred as biogenic fillers are flours obtained from fruits with hard shells or kernels, such as nuts or drupes, such as especially olive stone flour, coconut shell flour or (furthermore) walnut shell flour, but also hazelnut shell flour, almond flour, peach stone flour, apricot stone flour or cherry stone flour.

Plant charcoal is preferably a wood charcoal (such as barbecue charcoal), for example obtained from trees or shrubs or constituent parts thereof, for example from forestry waste, or from specific woods, such as hazelnut wood, lime wood, beech, alder or buckthorn charcoal, grapevine charcoal or medical charcoal (also in the form of activated charcoal. Relatively hydrophobic charcoals can be advantageous. Charcoals obtained by coking wood waste can be favourably used.

The biogenic materials, especially biogenic kernel or shell flours, are added, for example, in a proportion of from 5 to 80% by weight, for example from 10 to 55% by weight. An example of suitable proportions is in the range from 10 to 35% by weight; another example is in the range from 36 to 60% by weight.

“Comprise” or “include” means that other components or features may be present in addition to the components or features mentioned and therefore does not refer to an exhaustive list, unlike “contain”, the use of which does signify an exhaustive list of components or features.

Where the attribute “furthermore” is mentioned, this means that features without this attribute can be more preferred.

“And/or” means that the mentioned features/substances can in each case be present on their own or in a combination of two or more of the individually mentioned features/substances.

“A” usually denotes the indefinite article (except when it is recognisable as a number as immediately afterwards in this sentence) and especially means “at least one” (in the sense of 1, 2 or more).

As the synthetic resin there are used primarily reactive synthetic resins based on epoxy or free-radical-hardenable (=hardening after addition of a free-radical-former (hardener)) reactive synthetic resins, which in each case can be hardened by appropriate hardeners (hardener components) as described, for example, hereinbelow.

### Synthetic Resins Based on Epoxy:

The reactive synthetic resins based on epoxy that can be utilised in use of and/or in multi-component synthetic resin adhesive compositions according to the invention comprise an epoxy component, preferably based on glycidyl compounds, for example those having an average glycidyl group functionality of 1.5 or more, especially of 2 or more, for example from 2 to 10, which can optionally comprise further glycidyl ether(s) as reactive diluent. The epoxides of the epoxy component are preferably poly(including di)-glycidyl ethers of at least one polyhydric alcohol or phenol, such as novolak, bisphenol F or bisphenol A, or mixtures of such epoxides, for example obtainable by reaction of the corresponding polyhydric alcohols with epichlorohydrin. Examples are trimethylolpropane triglycidyl ether, novolak epoxy resins, bisphenol A epichlorohydrin resins and/or bisphenol F epichlorohydrin resins, for example having an average molecular weight of ≦2000. The epoxy resins can have, for example, an epoxy equivalent of from 120 to 2000, preferably from 150 to 400, such as especially from 155 to 195, for example from 165 to 185. The proportion in the total mass of the reactants and additives of the injectable synthetic mortar system is preferably from 5 to below 100% by weight, especially from 10 to 80% by weight, from 10 to 70% by weight, or from 10 to 60% by weight. Also possible are mixtures of two or more of such epoxy components. Suitable epoxy resins, reactive diluents and hardeners are also to be found in the reference work by Lee H and Neville K, “Handbook of Epoxy Resins” (New York: McGraw-Hill), 1982 (these compounds are incorporated herein by reference).

Preferably, in all embodiments of the invention, for curing, no input of heat and/or (for example, UV) light from the outside is necessary for their use; this means that the reaction proceeds especially at ambient temperature (for example, temperatures between −20 and 45° C., for example at 23° C.) and without additional heating or illumination by means of heating or illuminating devices and materials.

“Based on epoxy” means especially that the synthetic resin adhesive compositions according to the invention can also comprise, in addition to the components mentioned hitherto, further customary ingredients (for example, additives or other constituents mentioned hereinabove or hereinbelow). These further ingredients can be present, for example, in an amount of, in total, up to 80% by weight, preferably between 0.01 and 65% by weight. Even when “based on” is not explicitly mentioned, such customary ingredients are also included.

Important examples of further ingredients are one or more selected from accelerators, non-reactive diluents, reactive diluents, thixotropic agents, further fillers besides the mentioned fillers, and further additives.

As accelerators there may be included, for example, tert-amines, such as imidazoles or tert-aminophenols, such as 2,4,6-trimethylaminomethylphenol, organophosphines or Lewis bases or Lewis acids, such as phosphoric acid esters, or mixtures of two or more thereof, in one or (especially in the case of multi-component systems) more of the components, preferably in each case in a hardener component, for example in a proportion by weight of from 0.001 to 15% by weight, based on the total mass of the reactants and additives of the injectable synthetic mortar system.

As non-reactive diluents there can be added, for example, vegetable oils, such as castor oil, for example in a proportion of from 3 to 60% by weight, e.g. from 4 to 55% by weight.

As thixotropic agents there can be used customary rheology aids, such as pyrogenic silica (especially, for example, surface-treated to be made hydrophobic). They can be added, for example, in a proportion by weight of from 0.001 to 50% by weight, for example from 0.5 to 20% by weight.

As further fillers there can be used customary fillers, especially cements (for example Portland cements or alumina cements), chalks, sand, quartz sand, quartz powder or the like, which can be added in the form of powder, in granular form or in the form of shaped bodies, or other fillers, or mixtures thereof, it being possible for the fillers furthermore or especially also to be silanised.

The further fillers can be present in one or more components, for example of a multi-component kit according to the invention, for example in one or both components of a corresponding two-component kit; the proportion of further fillers is preferably from 0 to 90% by weight, for example from 10 to 90% by weight. Additionally or alternatively, hydraulically hardenable fillers such as gypsum, burnt lime or cement (for example, alumina cement or Portland cement), waterglasses, or active aluminium hydroxides, or two or more thereof, can be added.

Further additives can also be added, such as plasticisers, non-reactive diluting agents, flexibilisers, stabilisers, rheology aids, wetting and dispersing agents, colouring additives, such as dyes or especially pigments, for example for staining the components different colours for better monitoring of their intermixing, or the like, or mixtures of two or more thereof. Such further additives can preferably be added in total in proportions by weight of in total from 0 to 90%, for example from 0 to 40% by weight.

Some of the compounds mentioned in the definition of epoxides, such as trimethylolpropane triglycidyl ether or hexanediol diglycidyl ether or glycidylpropyltrimethoxysilane, which have a lower viscosity than epoxides comprising aromatic groups, can also be used as reactive diluents, for example in a proportion by weight of from 0.1 to 90% by weight, for example between 0.5 and 75% by weight or between 1 and 40% by weight.

The hardener comprises at least one compound customary for epoxy hardening (reaction partner in polyaddition), the term “hardener” meaning preferably at least one compound which is customary for epoxy hardening with or without addition of fillers (especially biogenic fillers according to the invention) and/or further additives such as water, thickeners and/or further additional substances, such as dyes and the like, in other words the complete hardener component. The hardener can be in the form of a separate component and/or also be incorporated (especially in protected form, that is to say, for example, in micro-encapsulated form) in the reactive resin formulation (in the form of a hardenable component, that is to say one which, after mixing with the hardener after breaking-open of the shell of the microcapsule, cures by means of polymerisation). Customary additives can be added such as, for example, fillers (especially as defined hereinabove) and/or solvents (especially for producing a paste or emulsion), such as benzyl alcohol and/or water.

The compounds customary for epoxy hardening (which function as reaction partners in the course of polyaddition) are especially those having two or more groups selected from amino, imino and mercapto, for example corresponding amines (preferred), thiols or aminothiols, or mixtures of two or more thereof, for example as mentioned in Lee H and Neville K, “Handbook of Epoxy Resins” (New York: McGraw-Hill), 1982, which is hereby incorporated by reference in this regard, for example di- or poly-amines and/or di- or poly-thiols which are mentioned therein.

In special embodiments of the invention, the compounds customary for epoxy hardening, the epoxy base or both have no rubber modification.

The compounds customary (generally) for epoxy hardening include, for example in an embodiment of the invention
di- or poly-amines such as especially aliphatic (such as ethylenediamine), cycloaliphatic and aromatic di- or poly-amines, amidoamines, amine adducts, polyether diamines or polyphenyl/polymethylenepolyamines, Mannich bases, polyamides and the like (special mention being made of Mannich bases, especially as disclosed in the publication WO 2005/090433, especially on page 3, final paragraph, to page 6, second paragraph, as in Example 1 or, especially, 2 thereof, which is incorporated herein by reference in this regard, on their own or in admixture with one or more further di- or poly-amines);
di- or poly-thiols such as especially di-functional or higher functional thiols, for example dimercapto-α,ω-C1-C12alkanes, 4,4′-dimercaptodicyclohexylmethane, dimercaptodiphenylmethane or the like;
furthermore aliphatic aminols such as especially hydroxy-lower alkyl-amines, such as ethanolamine, diethanolamine or 3-aminopropanol, or aromatic aminols, such as 2-, 3- or 4-aminophenol.

Mixtures of two or more of the mentioned compounds customary for epoxy hardening can also be used and/or included.

The compounds customary for epoxy hardening, where present, are present preferably in amounts of up to 95% by weight, preferably from 2 to 70% by weight, based on the total mass of reactants and additives in the mass of the synthetic resin adhesive composition to be cured (for example, the injectable synthetic resin system).

Based on the hardener component of a multi-component synthetic resin adhesive composition according to the invention, the proportion of the corresponding compounds in a possible preferred embodiment of the invention is from 1 to 95% by weight, for example 4 to 95% by weight, 5 to 90% by weight or 10 to 80% by weight.

Especially in the case of a hardener component of a multi-component system according to the invention, further additives can also be constituents of the “hardener”, such as water, organic solvents, such as benzyl alcohol, fillers (for example as mentioned hereinabove) and further additives from the additives mentioned hereinabove, for example in a proportion by weight of, in total, from 0.01 to 70% by weight, for example from 1 to 40% by weight.

### Free-Radical-Hardenable Reactive Synthetic Resins

The free-radical-hardenable reactive synthetic resins (preferred in embodiments of the invention) are primarily those based on free-radical-hardening unsaturated reactive resins and, present in a separate component, free-radical-forming hardeners.

Preferably, in all embodiments of the invention, for curing, no input of heat and/or (for example, UV) light from the outside is necessary for their use; this means that the reaction proceeds especially at ambient temperature (for example, temperatures between −20 and 45° C., for example at 23° C.) and without additional heating or illumination by means of heating or illuminating devices and materials.

Free-radical-hardening unsaturated reactive resins are to be understood as being primarily those which comprise, as free-radical-curing (which includes “curable (for example prior to addition of hardener)”) components, organic compounds having unsaturated (for example olefinic) radicals or, especially, which consist thereof, especially those which comprise 2 or more unsaturated (olefinic) radicals per molecule, primarily those which include hardenable esters with unsaturated carboxylic acid radicals; preferably in each case propoxylated or, especially, ethoxylated aromatic diol-, such as bisphenol-A-, bisphenol-F- or novolak-(especially di-)(meth)acrylate, epoxy(meth)acrylates, especially in the form especially of reaction products of di- or poly-epoxides, for example bisphenol-A-, bisphenol-F- or novolak-di- and/or -polyglycidyl ethers, with unsaturated carboxylic acids, for example C₂-C₇alkenecarboxylic acids, such as especially (meth)acrylic acid, urethane- and/or urea-(meth)acrylates (which also includes oligomeric or polymeric variants), and/or unsaturated polyester resins, or the like; or two or more of such hardenable unsaturated organic components; for example in a proportion by weight of from 0.1 to 90% by weight, for example between 0.5 and 75% by weight or between 1 and 40% by weight or from 40 to 65% by weight.

Examples of epoxy(meth)acrylates present or used in special embodiments of the invention are those of formula

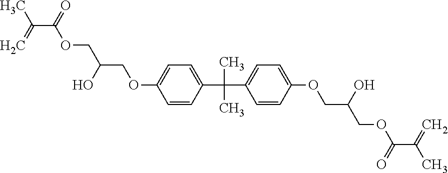 [SMILES: C=C(C)C(=O)OCC(O)COc1ccc(C(C)(C)c2ccc(OCC(O)COC(=O)C(=C)C)cc2)cc1]

or, more generally, taking into account the prelengthening reaction in the preparation of the bisphenol A diglycidyl ether of formula

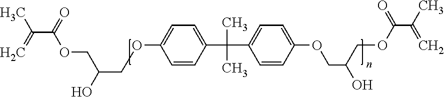

wherein n denotes a number greater than or equal to 1 (when mixtures of different molecules having different n values are present and are represented by the formula, non-integer numbers are also possible as a mean value). These too are subsumed hereinbelow under the term “vinyl esters”.

Examples of propoxylated or, especially, ethoxylated aromatic diol-, such as bisphenol-A-, bisphenol-F- or novolak-(especially di-)(meth)acrylates that can be present in and/or used in special embodiments of the invention are those of formula

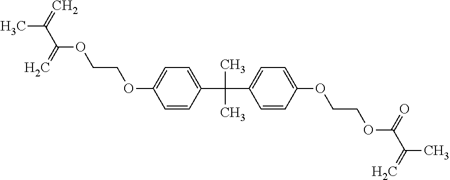 [SMILES: C=C(C)C(=C)OCCOc1ccc(C(C)(C)c2ccc(OCCOC(=O)C(=C)C)cc2)cc1]

or, generally, also taking into account higher degrees of ethoxylation:

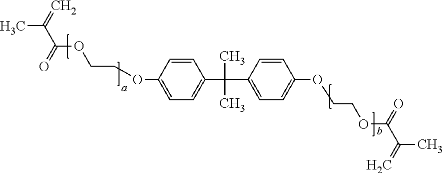

wherein a and b each independently of the other denote a number greater than or equal to 0, with the proviso that preferably at least one of the values is greater than 0, preferably both values being 1 or more (when mixtures of different molecules having different (a and b) values are present and are represented by the formula, non-integer numbers are also possible as a mean value, but for individual molecules seen in isolation only integers in each case). These too are subsumed hereinbelow under the term “vinyl esters”.

Important examples of further ingredients here are aminic accelerators, inhibitors, non-reactive diluents, reactive diluents, thixotropic agents, fillers (other than those already mentioned, that is to say further fillers) and/or further additives.

As aminic accelerators there come into consideration those having sufficiently great activity, such as especially (preferably tertiary, especially hydroxyalkylamino-group-substituted) aromatic amines selected from the group selected from epoxyalkylated anilines, toluidines or xylidines, such as, for example, ethoxylated toluidine, aniline or xylidine, for example N,N-bis(hydroxymethyl or hydroxyethyl)-toluidines or -xylidines, such as N,N-bis(hydroxypropyl or hydroxyethyl)-p-toluidine, N,N-bis(hydroxyethyl)-xylidine and more especially corresponding higher alkoxylated technical products. One or more such accelerators are possible. The accelerators preferably have a content (concentration) of from 0.005 to 10%, especially from 0.1 to 5% by weight.

As inhibitors there can be added, for example, non-phenolic (anaerobic) and/or phenolic inhibitors.

As phenolic inhibitors (which are often provided as a component already mixed in with commercial free-radical-hardening reactive resins but which, furthermore, may also be absent) there come into consideration (non-alkylated or alkylated) hydroquinones, such as hydroquinone, furthermore mono-, di- or tri-methyl hydroquinone, (non-alkylated or alkylated) phenols, such as 4,4′-methylene-bis(2,6-di-tert-butylphenol), 1,3,5-trimethyl-2,4,6-tris(3,5-di-tert-butyl-4-hydroxybenzyl)-benzene, (non-alkylated or alkylated) pyrocatechols, such as tert-butyl-pyrocatechol, 3,5-di-tert-butyl-1,2-benzenediol or, or especially 4-methoxyphenol, or mixtures of two or more thereof. These have preferably a content of up to 1% by weight, especially between 0.0001 and 0.5% by weight, for example between 0.01 and 0.1% by weight.

As non-phenolic or anaerobic (that is to say, unlike the phenolic inhibitors, active also without oxygen) inhibitors (which especially have scarcely any effect on the curing times) there come into consideration preferably phenothiazine or organic nitroxyl free radicals. As organic nitroxyl free radicals there can be added, for example, those described in DE 199 56 509, which are incorporated herein by reference especially in respect of the compounds mentioned therein, especially 1-oxyl-2,2,6,6-tetramethyl-piperidin-4-ol (“4-OH-TEMPO” or “TEMPOL”). The proportion by weight of the non-phenolic inhibitors is preferably in the range of from 1 ppm (by weight) to 2% by weight, especially, for example, in the range of from 10 ppm to 1% by weight, based on the reactive resin formulation.

As non-reactive diluents there can be added, for example, vegetable oils, such as castor oil, or furthermore bio-alcohols and fatty acids and esters thereof, or mixtures of two or more thereof, for example in a proportion of from 3 to 60% by weight, for example from 4 to 55% by weight.

As thixotropic agents there can be used customary thixotropy-imparting rheology aids, such as pyrogenic silica. They can be added, for example, in a proportion by weight of from 0.01 to 50% by weight, for example from 0.5 to 20% by weight.

As further fillers (besides the flours and powders according to the invention) there are used customary fillers, especially cements (for example Portland cements or alumina cements), chalks, sand, quartz sand, quartz powder or the like, which can be added in the form of powder, in granular form or in the form of shaped bodies, or others, or mixtures thereof, it being possible for the fillers furthermore or especially also to be silanised. The fillers can be present in one or more components of a multi-component synthetic resin adhesive composition according to the invention, for example one or both components of a corresponding two-component kit; the content of fillers is preferably from 0 to 90% by weight, for example from 10 to 50% by weight (in the case of the installation of anchoring elements, broken casing material (for example splintered glass or splintered plastics), for example fragments of capsules, can also be counted as filler). In addition or as an alternative to one or more of the mentioned fillers, hydraulically hardenable fillers, such as gypsum, burnt lime or cement (for example alumina cement or Portland cement), water glasses or active aluminium hydroxides, or two or more thereof, can be added.

Further additives can also be added, such as plasticisers, non-reactive diluting agents, flexibilisers, stabilisers, rheology aids, wetting and dispersing agents, colouring additives, such as dyes or especially pigments, for example for staining the components different colours for better monitoring of their intermixing, or the like, or mixtures of two or more thereof. Such further additives can preferably be added in total in proportions by weight of in total from 0 to 90%, for example from 0 to 40% by weight.

As “reactive diluents”, for example for preferred vinyl esters, it is possible, in addition, for one or more (relatively low-viscosity) free-radical-hardening unsaturated reactive diluents to be added, which are to be understood primarily as those which, as free-radical-curing (which includes “curable (for example prior to addition of hardener)”) components, organic compounds having unsaturated (for example, olefinic) radicals or which especially consist of such compounds, for example especially (meth)acrylate or (meth)acrylamide monomers, such as acrylic acid and/or methacrylic acid or preferably esters thereof (referred to as (meth)acrylates) or amides, especially (meth)acrylates such as mono-, di-, tri- or poly-(meth)acrylates (including hydroxyalkyl (meth)acrylates, such as hydroxypropyl (meth)acrylate or hydroxyethyl (meth)acrylate, alkyl (meth)acrylates having 1 to 10 (meth)acrylate groups, such as mono-, di-, tri-, tetra-, penta-, hexa- or poly-(meth)acrylates, for example alkyl di- or tri-(meth)acrylates, such as 1,2-ethanediol di(meth)acrylate (ethylene glycol di(meth)acrylate), butanediol di(meth)acrylate, such as 1,3- or especially 1,4-butanediol di(meth)acrylate, hexanediol di(meth)acrylate, 1,10-decanediol di(meth)acrylate, diethylglycol di(meth)acrylate, trimethylolpropane tri(meth)acrylate, glycerol tri(meth)acrylate, polyglycerol poly(meth)acrylate, polyethylene glycol di(meth)acrylate, cycloalkyl (meth)acrylates, bicycloalkyl (meth)acrylates or heterocyclyl (meth)acrylates, wherein cycloalkyl or bicycloalkyl has from 5 to 7 ring carbon atoms and heterocyclyl has 5 or 6 ring atoms and 1 or 2 ring hetero atoms selected from N, O and S, such as tetrahydrofurfuryl (meth)acrylate or isobornyl (meth)acrylate, or acetacetoxyalkyl (meth)acrylate; or furthermore styrenes, such as styrene, α-methyl styrene, vinyl toluene, tert-butyl styrene and/or divinyl benzene; or mixtures of two or more thereof, to be provided as constituents that cure in parallel with the free-radical-hardening unsaturated reactive resin, for example in a proportion by weight of from 0.1 to 90% by weight, for example between 0.5 and 75% by weight or between 1 and 40% by weight.

The hardener includes at least one peroxide as actual initiator. The term “hardener” here preferably hereinabove and hereinbelow means pure initiators or stabilised initiators, with or without addition of filler, and/or further additives, such as water, thickeners and/or further additional substances, such as dyes, pigments, additives and the like, in other words the complete hardener component. For stabilisation, customary additives, such as gypsum, chalk, pyrogenic silica, phthalates, chlorinated paraffin or the like, can be added. In addition, fillers and/or (especially for the preparation of a paste or emulsion) solvents (non-reactive diluting agents such as, for example, liquid (for example, also epoxidised or hydroxyl-group-containing) oils, for example castor oil, or water, thickeners, fillers (for example those mentioned above) and further additives of those mentioned above can also be added, it being possible for water to serve as hardener for the condensation of silanes that include hydrolysable groups. The content of all additives can be, for example, a proportion by weight of in total from 0.1 (especially 10) to 99.5% by weight, for example from 1 (especially 10) to 99.1% by weight.

Based on the hardener component, the content of initiator (actual hardener) in a possible preferred embodiment of the invention is from 0.5 to 90% by weight, especially from 0.9 to 30% by weight.

As initiator for the hardening of the reactive resin formulations according to the invention there are used in the case of free-radical polymerisation, for example free-radical-forming peroxides, for example organic peroxides, such as diacyl peroxides, for example dibenzoyl peroxide, ketone peroxides, such as methyl ethyl ketone peroxide or cyclohexanone peroxide, or alkyl peresters, such as tert-butyl perbenzoate, inorganic peroxides, such as persulfates or perborates, and also mixtures thereof.

The proportion of hardener in a synthetic resin adhesive composition according to the invention, based on the mass (weight) of all reactants and additives without packaging, preferably lies in a range of from 1 to 60% by weight, for example from 2 to 50% by weight, it being possible for the proportion of peroxide, likewise based on the mass of the total associated reactive resin formulation (100%), to be 0.1 or more % by weight, in an especially preferred embodiment from 0.1 to <1% by weight, furthermore also from 1 to 10% by weight.

The free-radical-hardenable unsaturated reaction resin (and/or the totality of its components) is provided, for example, in a proportion by weight of from 5 to 99.5%, such as for instance from 10 to 98.5%, for example from 10 to 89.5%.

Here too, “based on” means that the synthetic resin adhesive compositions according to the invention can also include, in addition to the mentioned components, further customary ingredients (for example additives or other constituents mentioned above or below). Such further ingredients can be present together, for example in an amount of in total up to 80% by weight, preferably between 0.01 and 65% by weight. Even where “based on” is not expressly mentioned, such customary ingredients are included.

A hole or crevice is to be understood as being a hole or crevice that is present in a solid substrate (especially already completed as such), especially masonry or concrete, optionally also in a cracked substrate, such as cracked concrete, and is accessible from at least one side, for example a drilled hole, or furthermore a recessed region made during mortaring with inorganic mortar or plastering materials (such as cement or gypsum), or the like.

In a special embodiment of the invention, the hardenable components and the associated hardeners (hardener components) are stored separately from one another in a two-component or multi-component system before they are mixed with one another at the desired site (for example close to or in a hole or crevice, such as a drilled hole).

The injectable synthetic resin systems according to the invention are provided as multi-component systems (for example, a multi-component kit) and are also used as such.

A multi-component kit is understood to be especially a two-component or (furthermore) multi-component kit (preferably a two-component kit) having a component (A), which comprises either one or more free-radical-hardenable (=hardening after addition of a free-radical-former (hardener)) reactive synthetic resins or one or more reactive synthetic resins based on epoxy, as described hereinabove and hereinbelow, and the respective associated hardener (component (B)), as described hereinabove and hereinbelow, it being possible for further additives to be provided in one or both of the components, preferably a two-chamber or furthermore multi-chamber apparatus, wherein the components (A) and (B) that are able to react with one another and optionally further separate components are present in such a way that their constituents cannot react with one another (especially not curing) during storage, preferably in such a way that their constituents do not come into contact with one another prior to use, but that enables components (A) and (B) and optionally further components to be mixed together for fixing at the desired location, for example directly in front of or in a hole, and, if necessary, introduced in such a way that the hardening reaction can take place therein. Also suitable are capsules, for example made of plastics, ceramics or especially glass, in which the components are arranged separated from one another by means of rupturable boundary walls (which can be ruptured, for example, when an anchoring element is driven into a hole or crevice, such as a drilled hole) or integrated separate rupturable containers, for example in the form of capsules, such as ampoules, arranged one inside the other; and also especially multi-component or especially two-component cartridges (which are likewise especially preferred), the chambers of which contain the plurality of components or preferably the two components (especially (A) and (B)) of the synthetic resin adhesive composition according to the invention having the compositions mentioned hereinabove and hereinbelow for storage prior to use, the kit in question preferably also including a static mixer.

Advantageously, the packaging materials (such as films, cartridges (also static mixers) or plastics capsules) can likewise be made from plastics having a high or completely biogenic carbon content, for example from corresponding polyamides or the like.

The use of a synthetic resin adhesive composition according to the invention at the desired site of use is effected by mixing the associated components (separated before mixing so as to inhibit a reaction), especially close to or directly in front of a hole or (for example especially when cartridges having static mixers are used) directly in front of and/or (especially when suitable capsules or ampoules are broken) inside a hole or crevice, for example a drilled hole.

“Embedding in mortar” is especially to be understood as meaning (material-bonded and/or interlocking) fixing of anchoring means made of metal (for example undercut anchors, threaded rods, screws, drill anchors, bolts) or, furthermore, made of some other material, such as plastics or wood, in solid substrates (preferably already completed as such), such as concrete or masonry, especially insofar as they are components of artificially erected structures, more especially masonry, ceilings, walls, floors, panels, pillars or the like (for example made of concrete, natural stone, masonry made of solid blocks or perforated blocks, furthermore plastics or wood), especially in holes, such as drilled holes. Those anchoring means can then be used to secure, for example, railings, covering elements, such as panels, façade elements or other structural elements.

Where “mixtures of two or more thereof” are mentioned, this includes especially mixtures of at least one of the mentioned constituents, which are emphasised as being preferred, with one or more other components, especially one or more components likewise identified as being preferred.

“Completed as such” means especially that the substrates are, except for possible surface modifications (such as coating, for example plastering or painting) or the like, already completed (for example, as building modules or walls) and are not completed only at the same time as the adhesive composition or are not made from the latter. In other words: the adhesive composition itself is not, then, already-completed substrate.

The introduction of the anchoring means is preferably effected only a short time, preferably 30 minutes or less, after the components of the fixing mortar according to the invention have been mixed together. In explanation: the mixing/introduction of the components at/into the desired locations at which anchoring means are to be fixed initiates a plurality of reactions which proceed substantially in parallel and/or with only a very small time interval between them. The final curing takes place in situ.

By means of the following test system (especially as described in greater detail in the Examples), the following ranges for bond strength can be found: more than 10 N/mm², for example 10 to 100 N/mm² such as, for example, 12 to 50 N/mm², e.g. 15 to 30 N/mm².

The bond strength is determined by pull-out tests on M12 anchor rods from concrete (C20/C25) with an insertion depth of 95 mm and a drilled hole diameter of 14 mm, after a curing time of 60 minutes at 20° C.

Specific embodiments of the invention also relate to the variants mentioned in the claims and abstract—the claims and the abstract are incorporated herein by reference.

The Examples that follow serve to illustrate the invention, without limiting its scope, but also show embodiments of the invention (it also being possible for each individual specifically mentioned constituent to be used in any of the subject-matter of the invention mentioned hereinabove and hereinbelow instead of a general term, or a plurality or all thereof, which defines special embodiments of the invention).

### ABBREVIATIONS

EOBADMA: ethoxylated bisphenol-A dimethacrylate
BDDMA: butanediol dimethacrylate
t-BBC: tert-butyl pyrocatechol
FIS V: FIS V 360 S (fischerwerke GmbH & Co. KG, Waldachtal, Germany)

### EXAMPLE 1

The corresponding amounts of flours were incorporated into a basic resin comprising 66.67% EOBADMA and 33.33% BDDMA, and the viscosity was determined using a Brookfield viscometer at 23° C. Up to about 10,000 mPas a no. 3 spindle was used at 20 rpm, and above that a no. 7 spindle was used at 10 rpm.

Measurement values in mPas:

| Concentration | Olive stone | Coconut | | | Arbocel | |
|---|---|---|---|---|---|---|
| [% by | flour M200 | shell flour | Rehofix | Jeluxyl | Type | Lignocel |
| weight] | (preferred) | (preferred) | MK300 | Haho | C750FP | C120 |
| 12.2 | 140 | 145 | 160 | 750 | 1720 | 2000 |
| 23.4 | 300 | 285 | 600 | Measurement | 156000* | 141000* |
| | | | | no | | |
| | | | | longer | | |
| | | | | possible | | |
| 34.6 | 845 | 800 | 15,400 | | | |
| 41.4 | 6405 | 3670 | Measurement | | | |
| | | | no | | | |
| | | | longer | | | |
| | | | possible | | | |
| 46.9 | 18,000 | 14,400 | | | | |
| 51.4 | 48,800 | 35,000 | | | | |

*= mortar too dry and crumbly, no longer flowable

The following materials were used:

| Filler | Type | Supplier |
|---|---|---|
| Olive stone flour | Olive stone flour | A+S BioTec, Völklingen |
| | M200 | |
| Coconut shell flour | Coconit 200 | Mahlwerk Neubauer-Friedrich |
| | | Geffers GmbH, Hamburg |
| Plant granules | Rehofix MK300 | J. Rettenmaier & Söhne GmbH |
| | | & Co, Rosenberg |
| Hardwood powder | Jeluxyl HaHo 120/f. | JELU-WERK J. Ehrler GmbH |
| | Arbocel Type C 750 | & Co. KG, Rosenberg |
| Crude cellulose | FP | J. Rettenmaier & Söhne GmbH |
| | | & Co, Rosenberg |
| Wood fibres from | Lignocel C120 | J. Rettenmaier & Söhne GmbH |
| coniferous trees | | & Co, Rosenberg |

It can be seen that good degrees of filling were achieved only with the flours, and other fillers resulted in unusable mortars even at very low degrees of filling.

Mechanical Characterisation:

For the gel time determination and preparation of the compression and tension testing specimens, a standard mortar was produced with 76.6% liquid component (BDDMA/E2BADMA) and 23.4% bio-based filler (mortar from line 2 (emphasised in bold) in the Table above), to which there was added 0.7% of an aminic accelerator.

50 g of each mortar were mixed with 9.1 g of a hardener having a dibenzoyl peroxide content of 5.3% by weight and test specimens were produced.

Tension results, measured in accordance with

DIN EN ISO 527 on 1 BA test specimens

| | | Tensile | Extension at |
|---|---|---|---|
| Mortar having bio- | Tensile strength | modulus | tensile |
| based filler | [Mpa] | [Gpa] | strength [%] |
| Olive stone flour | 23.2 | 2.5 | 1.1 |
| M200 | | | |
| Coconit 200 | 18.1 | 2.4 | 0.9 |
| Lignocel C 120 | 17.8 | 2.5 | 0.8 |
| Rheofix MK 300 | 12.2 | 2.2 | 0.6 |
| Jeluxyl Haho 120 | 12.6 | 2.2 | 0.6 |
| Arbocel Type | 19.0 | 2.51 | 0.8 |
| C750FP | | | |
| Comparison: FIS V | 10.0 | 4.3 | 0.5 |

Result: Good to very good tensile strengths were found with all the fillers, those for the flours being in the upper range, with the olive stone flour being the highest. The extension at tensile strength was highest with the flours.

Gel Time:

For the determination 50.0 g of mortar and 9.1 g of hardener as mentioned above were weighed out, homogenised for 1 minute, and the solidification measured at 23+/−1° C.

| Mortar having bio-based filler | Gel time [mm:ss] |
|---|---|
| Olive stone flour M200 | 04:11 |
| Coconit 200 | 03:45 |
| Lignocel C 120 | 06:30 |
| Rheofix MK 300 | 04:42 |
| Jeluxyl Haho 120 | 04:36 |
| Arbocel Type C750FP | 04:43 |

The result is that the gel times are substantially equal (and consequently there are no indications of inhibitory action or any influence of the filler type).

### EXAMPLE 2

### Example Formulation 1

Mortar component 1

| | Amount used |
|---|---|
| Raw material | [% by weight] |
| tetrahydrofurfuryl methacrylate Sarbio | 9.90 |
| 6100 | |
| ethoxylated bisphenol-A | 19.00 |
| dimethacrylate | |
| inhibitor mixture (t-BBC, TEMPOL) | 0.05 |
| aminic accelerator | 0.65 |
| pyrogenic surface-treated silica | 1.50 |
| quartz powder | 41.90 |
| olive stone flour | 27.00 |
| | 100.00 |

The mortar has a density of 1.58 g/ccm and a viscosity of 160 Pa*s at 23° C., measured using a Brookfield no. 7 spindle at 10 rpm. The bio-carbon content is 50.5%.

Hardener component 1

| | Amount used |
|---|---|
| Raw material | [% by weight] |
| castor oil | 40.00 |
| dibenzoyl peroxide 33% in inert filler | 16.00 |
| quartz powder | 41.50 |
| pyrogenic surface-treated silica | 2.00 |
| pigment | 0.50 |
| | 100.00 |

The hardener has a density of 1.50 g/ccm and a viscosity of 120 Pa*s at 23° C., measured using a Brookfield no. 7 spindle at 10 rpm. The bio-carbon content is 88.9%.

Measurement of Bond Strength:

A 5:1 coaxial cartridge of biopolyamide 6.10 (58% bio-C) is filled with about 390 g of the mortar and about 74 g of the hardener. The injectable mortar (hardener component (component B)) and mortar component 1 (component A)) together) has a bio-carbon content of 56.5%.

Pull-out values: The bond strength is determined by pull-out tests on M12 anchor rods from concrete (C20/C25) with an insertion depth of 95 mm and a drilled hole diameter of 14 mm, after a curing time of 60 minutes at 20° C. A bond strength of 18.6 N/mm² is obtained.

### Example Formulation 2

Mortar component 2

| | Amount used |
|---|---|
| Raw material | [% by weight] |
| 1,10-decanediol diacrylate | 11.50 |
| (Sarbio 5201) | |
| ethoxylated bisphenol-A | 19.00 |
| dimethacrylate | |
| inhibitor mixture (t-BBC, TEMPOL) | 0.05 |
| aminic accelerator | 0.65 |
| pyrogenic surface-treated silica | 1.50 |
| quartz powder | 40.30 |
| coconut shell flour Coconit 200 | 27.00 |
| | 100.00 |

The mortar has a density of 1.56 g/ccm and a viscosity of 145 Pa*s at 23° C., measured using a Brookfield no. 7 spindle at 10 rpm. The bio-carbon content is 51%.

Measurement of Bond Strength:

A 5:1 coaxial cartridge of biopolyamide 6.10 (58% bio-C) is filled with about 385 g of the mortar component and about 74 g of hardener component 1. The injectable mortar (hardener component (component B)) and mortar component 1 (component A)) from Example 1 together) has a bio-carbon content of 56.9%. A bond strength of 18.3 N/mm² is obtained here.

### EXAMPLE 3

Mortar component 3

| | Amount used |
|---|---|
| Raw material | [% by weight] |
| bisphenol A/F resin | 45 |
| (bio-C content 28%) | |
| trimethylolpropane triglycidyl ether | 15 |
| wetting and dispersing agent | 2 |
| pigment | 0.5 |
| pyrogenic surface-treated silica | 2 |
| quartz powder | 10.5 |
| coconut shell flour | 25 |
| | 100.00 |

The mortar has a density of 1.31 g/ccm and a viscosity of 140 Pa*s at 23° C., measured using a Brookfield no. 7 spindle at 10 rpm. The bio-carbon content is 39%.

Hardener component 2

| | Amount used |
|---|---|
| Raw material | [% by weight] |
| Mannich base formulation | 60 |
| vegetable charcoal | 37.5 |
| pyrogenic surface-treated silica | 2.00 |
| pigment | 0.50 |
| | 100.00 |

The hardener has a density of 1.28 g/ccm and a viscosity of 160 Pa*s at 23° C., measured using a Brookfield no. 7 spindle at 10 rpm. The bio-carbon content is 38%.

Measurement of Bond Strength:

A 3:1 coaxial cartridge of biopolyamide 6.10 (58% bio-C) is filled with about 393 g of the mortar and about 130 g of the hardener. The bond strength determined is 24.7 N/mm².

1. A multi-component synthetic resin adhesive composition for fixing, comprising one or more fillers, and wherein the synthetic resin adhesive composition comprises a biogenic filler.

2. The synthetic resin adhesive composition according to claim 1, comprising, as biogenic filler, at least one of flours, brans, sugars, (poly)saccharides, plant fibres, alkyl (poly)glycosides, tannins, lignins, lignin sulfonates or latex, or mixtures of two or more thereof.

3. The synthetic resin adhesive composition according to claim 1, comprising, as biogenic filler, at least one of kernel flours or shell flours or kernel powders or shell powders obtained from plant fruits and/or biogenic charcoal, or mixtures of two or more thereof.

4. The synthetic resin adhesive composition according claim 1, comprising, as biogenic filler, biogenic charcoal.

5. The synthetic resin adhesive composition according to claim 1, comprising, as biogenic filler, at least one of olive stone flour, coconut shell flour, walnut shell flour, hazelnut shell flour, almond flour, peach stone flour, apricot stone flour or cherry stone flour, or mixtures of two or more thereof.

6. The synthetic resin adhesive composition according to claim 5, comprising, as biogenic filler, at least one of olive stone flour or coconut shell flour, or mixtures thereof.

7. The synthetic resin adhesive composition according to claim 1, wherein the biogenic filler, in total, is provided in a proportion of from 5% to 80% by weight of the synthetic resin adhesive composition.

8. The synthetic resin adhesive composition according to claim 1, wherein the synthetic resin adhesive composition is a two-component kit, having a reactive synthetic resin component (A) and a hardener component (B).

9. The synthetic resin adhesive composition according to claim 8, comprising the biogenic filler in the synthetic resin component (A).

10. The synthetic resin adhesive composition according to claim 1, comprising, as a reactive synthetic resin component (A), a reactive synthetic resin based on epoxy or a free-radical-hardenable reactive synthetic resin, and also comprising a hardener component (B).

11. The synthetic resin adhesive composition according to claim 10, comprising, as reactive synthetic resin component (A), a free-radical-hardenable reactive synthetic resin and, as hardener component (B), a component having a peroxide as initiator.

12. The synthetic resin adhesive composition according to claim 11, comprising, in the or a reactive synthetic resin component (A), epoxy(meth)acrylates of formula 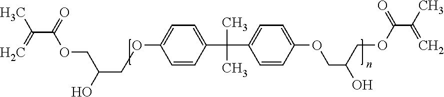
wherein n denotes a number greater than or equal to 1, and/or propoxylated or ethoxylated aromatic diol-(meth)acrylates of formula 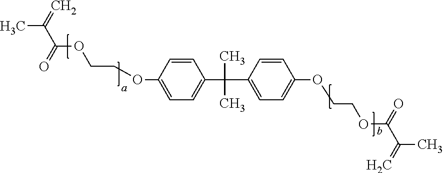
wherein a and b each independently of the other denote a number greater than or equal to 0, with the proviso that preferably at least one of the values is greater than 0, preferably both values being 1 or more, and/or one or more urethane (meth)acrylates.

13. The synthetic resin adhesive composition according to claim 1, wherein the hardenable (=hardening in the presence of hardener) reactive resin(s) based on epoxy in the reactive synthetic resin component (A) comprise(s), as epoxy, polyglycidyl ethers of novolak, bisphenol F or bisphenol A, or mixtures of such epoxides, and, in the hardener component (B), as hardener, those having two or more groups selected from amino, imino and mercapto, for example corresponding amines or thiols, or furthermore thioalcohols, aminoalcohols or aminothiols, or mixtures of such compounds.

14. The synthetic resin adhesive composition according to claim 1, comprising one or more further additives, selected from aminic accelerators, inhibitors (only in the case of free-radical-hardenable reactive resins), reactive diluents, thixotropic agents, further fillers and furthermore further additives selected from plasticisers, non-reactive diluting agents, reactive diluting agents, flexibilisers, stabilisers, rheology aids, wetting and dispersing agents and colouring additives.

15. The synthetic resin adhesive composition according to claim 1, comprising:
a.) a hardenable reactive resin;
b.) a hardenable reactive diluent having a viscosity <800 mPa*s, measurable using a Brookfield viscometer at 23° C. with a no. 3 spindle at 20 rpm;
c.) a hardener, by means of which a.) and b.) are hardened and/or by means of which the hardening thereof is initiated; and
d.) a biogenic filler.

16. The synthetic resin adhesive composition according to claim 1, comprising:
a.) a reactive resin having 2 or more unsaturated groups;
b.) a reactive diluent having unsaturated groups and having a viscosity <800 mPa*s; measurable using a Brookfield viscometer at 23° C. with a no. 3 spindle at 20 rpm;
c.) an aminic accelerator;
d.) an inhibitor;
e.) a free-radical initiator; and
f.) at least 5% of a biogenic filler.

17. The synthetic resin adhesive composition according to claim 1, comprising a reactive synthetic resin component (A) such that it comprises at least one biogenic filler, an epoxy(meth)acrylate and/or a propoxylated or ethoxylated aromatic diol-di(meth)acrylate, and/or a urethane (meth)acrylate, at least one reactive diluent in the form of an olefinic compound, especially selected from especially (meth)acrylate monomers or (meth)acrylamide monomers, such as acrylic acid and/or methacrylic acid or preferably esters or amides thereof, especially (meth)acrylates such as mono-, di-, tri- or poly-(meth)acrylates (including hydroxyalkyl (meth)acrylates, such as hydroxypropyl (meth)acrylate or hydroxyethyl (meth)acrylate, alkyl (meth)acrylates having from 1 to 10 (meth)acrylate groups, such as mono-, di-, tri-, tetra-, penta-, hexa- or poly-(meth)acrylates, for example alkyl di- or tri-(meth)acrylates, such as 1,2-ethanediol di(meth)acrylate (ethylene glycol di(meth)acrylate), butanediol di(meth)acrylate, such as 1,3- or especially 1,4-butanediol di(meth)acrylate, hexanediol di(meth)acrylate, 1,10-decanediol di(meth)acrylate, diethylglycol di(meth)acrylate, trimethylolpropane tri(meth)acrylate, glycerol tri(meth)acrylate, polyglycerol poly(meth)acrylate, polyethylene glycol di(meth)acrylate, cycloalkyl (meth)acrylates, bicycloalkyl (meth)acrylates or heterocyclyl (meth)acrylates, wherein cycloalkyl or bicycloalkyl has from 5 to 7 ring carbon atoms and heterocyclyl has 5 or 6 ring atoms and 1 or 2 ring hetero atoms selected from N, O and S, such as tetrahydrofurfuryl (meth)acrylate or isobornyl (meth)acrylate, and acetacetoxyalkyl (meth)acrylate; or furthermore styrenes, such as styrene, α-methyl styrene, vinyl toluene, tert-butyl styrene and/or divinyl benzene; and from mixtures of two or more thereof, a phenolic and/or a non-phenolic inhibitor, an aminic accelerator, a thixotropic agent and optionally a further filler, and as hardener component (B) a free-radical-forming peroxide, optionally a filler, a thixotropic agent and optionally a pigment.

18. The synthetic resin adhesive composition according to claim 1, wherein the synthetic resin adhesive composition is a two-component system, in the form of a two-chamber cartridge with or without a static mixer.

19. A method of using a synthetic resin adhesive composition according to claim 1, comprising introducing the synthetic resin adhesive composition and an anchoring means into a hole or crevice, and causing the synthetic resin adhesive composition to cure.

20. (canceled)

21. A method of producing the synthetic resin adhesive composition according to claim 1, comprising introducing one or more fillers, the one or more fillers including the biogenic filler.
